(19) United States
(12) Patent Application Publication
(10) Pub. No.: US 2003/0167251 A1
(43) Pub. Date: Sep. 4, 2003

(54) Highlight production, promotion and internet posting

(76) Inventor: Reginald Delrae Samuel, Ruther Glen, VA (US)

Correspondence Address: Reginald Delrae Samuel, 2603 Quail Oak Drive, Ruther Glen, VA, 22546, US

(21) Appl. No.: 10/085,876

(22) Filed: Mar. 1, 2002

(51) Int. Cl. G06F 7/00

(52) U.S. Cl. 707/1

(57) ABSTRACT

This concept brings forth the production of high school athletic highlight films. This highlight footage is then posted onto the Internet so that it may be viewed by college coaches and recruiters across the nation.

### BACKGROUND OF THE INVENTION

This concept brings forth the production, promotion and posting on the Internet of game footage which highlights the talents of high school athletes who wish to take their athleticism to the next level of competition, thus making them more marketable.

### BRIEF SUMMARY OF THE INVENTION

The highlight production, promotion and Internet Posting concept helps eliminate the tremendous amount of time and money that is spent in the recruiting process by athletic coaches and recruiters. Additionally, it is an added benefit to anyone who wishes to take his or her athletic performance to the next level of intercollegiate competition. Being that all of an individual's capabilities and performance potential is highlighted onto one source of output, it not only is an incentive to the recruiters but to the athlete as well.

After the digitally mastered video is produced, it will be posted onto a web site to viewed by college coaches and recruiters across the nation. This will greatly increase the likelihood of the highlight footage being viewed by individuals who have a desire to bring highly capable athletes into their athletic programs. The key objective of this concept is to assist college coaches and recruiters in locating quality athletes, while at the same time assisting competitive athletes in their attempts to become recognized by coaches and recruiters who may offer them scholarships or other contracts of value.

### DETAILED DESCRIPTION OF THE INVENTION

By utilizing various sports listings and publications, our company will strive to contact every athlete across the nation who has been acknowledged as being of exceptional quality. Once these individuals are located, they will be presented with packages describing our product and how much it may potentially benefit them. If they decide that this product will be beneficial enough for them to invest in, they will then submit to us all of the game footage and interview material in which they have access to.

We will then evaluated the received game footage and interview material and the portions of the provided material in which we deem to be exceptional will be cut and pasted together using digital based video production equipment. Not only will these video clips be edited into one video document; there will also be music, voice-overs and graphics added onto the video document.

After the video is produced, it will be digitally formatted so that it may be viewed via the Internet and placed onto a secured website that will only be accessible with a unique identification code and password.

In this portion of the process, we will approach several of the premier athletic programs across the nation and present them with a packet informing them of our product. Within this packet they will be informed that once a membership fee is received they will be provided with a password that will allow them to access game footage of some of the most highly regarded athletes in the country. By utilizing this product they will save a tremendous amount of money that would have otherwise been spent on the travel and lodging cost incorporated with recruiting. Now as opposed to physically attending the games of every athlete that they would potentially like to make an offer to, they can simply access our site and see first hand the potential worth that an athlete may bring to their program.

One of the key benefits of this concept is that is sufficiently serves both ends of the athletic recruitment spectrum. Both athlete and coach/recruiter have an intensified connection by utilizing this product.

1. What I claim as my invention is the production and posting of athletic highlight footage onto a website that will enable each players' performance to be evaluated by any entity that has an interest in the capabilities and talents of these athletes.
